(19) United States
(12) Patent Application Publication
(10) Pub. No.: US 2026/0095733 A1
(43) Pub. Date: Apr. 2, 2026

(54) Cross-Device Guest Pairing and Sensor Data Routing

(71) Applicant: Apple Inc., Cupertino, CA (US)

(72) Inventors: Jacob S WEISS, Los Angeles, CA (US); Sriram HARIHARAN, San Jose, CA (US)

(21) Appl. No.: 19/336,729

(22) Filed: Sep. 23, 2025

Related U.S. Application Data
(60) Provisional application No. 63/700,265, filed on Sep. 27, 2024.

(51) Int. Cl. H04W 4/80; G06F 3/16; H04W 12/033; H04W 12/50

(52) U.S. Cl. CPC H04W 4/80; G06F 3/162; H04W 12/033; H04W 12/50

(57) ABSTRACT

An apparatus configured to connect to a wireless communication device associated with a wireless audio output device for a first communication session between the apparatus and the wireless communication device, receive an encryption key from the wireless communication device, establish a guest pairing link with the wireless audio output device using the encryption key and generate, for transmission to the wireless audio output device, audio data for the communication session.

### PRIORITY/INCORPORATION BY REFERENCE

This application claims priority to U.S. Provisional Application Ser. No. 63/700,265 filed on Sep. 27, 2024, and entitled “Cross-Device Guest Pairing and Sensor Data Routing,” the entirety of which is incorporated by reference herein.

### BACKGROUND

A wireless communication device may provide audio data to one or more audio output devices using a short-range communication protocol. For example, a user may have the wireless communication device and a pair of wireless audio buds or wireless headphones. The wireless communication device may communicate with the wireless audio buds or headphones using a short-range communication protocol, such as Bluetooth. Once connected, the user may listen to music, a call or any other type of audio with the wireless audio buds or headphones.

In some situations, a user may be in an environment that is not a typical location such as home or office. For example, a user may be in a hotel or other location and want to use a secondary source device other than the wireless communication device for audio and video. In this situation, it may be desirable to connect and guest pair the wireless communication device and/or the wireless audio output device or other audio output devices to the secondary source device.

Further, it may be useful to be able to route sensor data from an accessory device (e.g., wireless audio buds) to a particular secondary source device or wireless communication device regardless of connection status.

### SUMMARY

Some example embodiments are related to an apparatus having processing circuitry coupled to memory, wherein the processing circuitry is configured to connect to a wireless communication device associated with a wireless audio output device for a first communication session between the apparatus and the wireless communication device, receive an encryption key from the wireless communication device, establish a guest pairing link with the wireless audio output device using the encryption key and generate, for transmission to the wireless audio output device, audio data for the communication session.

Other example embodiments are related to an apparatus having processing circuitry coupled to memory, wherein the processing circuitry is configured to connect to a wireless communication device associated with a wireless audio output device for a first communication session between the apparatus and the wireless communication device, establish a link with the wireless audio output device, advertise that sensor data is available from the wireless audio output device, receive a request from the wireless communication device for the sensor data, forward the request for sensor data to the wireless audio output device, receive sensor data from the wireless audio output device in response to the forwarded request and cause transceiver circuitry to forward the sensor data to the wireless communication device.

Still further example embodiments are related to an apparatus having processing circuitry coupled to memory, wherein the processing circuitry is configured to connect to a wireless communication device associated with a wireless audio output device for a first communication session between the apparatus and the wireless communication device, establish a link with the wireless audio output device, advertise that sensor data is available from the wireless audio output device, receive a request from the wireless communication device for the sensor data, forward the request for sensor data to the wireless audio output device, receive sensor data from the wireless audio output device in response to the forwarded request and cause transceiver circuitry to forward the sensor data to the wireless communication device.

Additional example embodiments are related to an apparatus having processing circuitry coupled to memory, wherein the processing circuitry is configured to connect and pair to a wireless communication device for a first communication session between the apparatus and the wireless communication device, receive an encryption key from the wireless communication device, the encryption key being temporary for the first communication session, connect to a secondary source device linked to the wireless communication device through a guest pairing link using the encryption key and receive audio data for the first communication session from the secondary source device.

### BRIEF DESCRIPTION OF THE DRAWINGS

FIG. 1 shows an example arrangement of a wireless communication device and wireless audio output device according to various example embodiments.

FIG. 2 shows an example wireless communication device according to various example embodiments.

FIG. 3 shows an example audio output device according to various example embodiments.

FIGS. 4A-4D illustrate example connections between a wireless communication device, a set of wireless audio output devices, and a secondary source device in an example communications session according to various embodiments.

FIG. 5 shows an example flow diagram for a method of communicating wirelessly between a wireless communication device, a set of wireless audio output devices, and a secondary source device in an example communications session that uses a guest pairing between the wireless audio output device and the secondary source device according to various embodiments.

FIGS. 6A-6D illustrate example connections between a wireless communication device, a set of wireless audio output devices, and a secondary source device in an example communications session where sensor data is sent from the wireless audio output devices to the wireless communication device through the secondary source device acting as a relay according to various embodiments.

FIG. 7 shows an example flow diagram for a method of communicating wirelessly between a wireless communication device, a set of wireless audio output devices, and a secondary source device in an example communications session where sensor data is sent from the wireless audio output devices to the wireless communication device through the secondary source device acting as a relay according to various embodiments.

FIG. 8 shows an example secondary source device according to various example embodiments.

### DETAILED DESCRIPTION

The example embodiments may be further understood with reference to the following description and the related appended drawings, wherein like elements are provided with the same reference numerals. The example embodiments relate to implementing techniques for guest pairing wireless audio output devices and/or a wireless communication device to a secondary source device. The example embodiments also relate to routing sensor data from an accessory device to a particular secondary source device or a wireless communication device, regardless of connection status.

The example embodiments are described with regard to the wireless communication device providing audio data to one or more wireless audio output devices. Throughout this description, the terms “wireless communication device” and “source device” may be used interchangeably. However, any reference to a wireless communication device or a source device is merely provided for illustrative purposes. The example embodiments may be utilized with any electronic component equipped with hardware, software, and/or firmware configured to communicate with wireless audio output devices using a short-range communication protocol.

The wireless communication device may communicate with one or more wireless audio output devices. The term “wireless audio output device” generally refers to an electronic device that is configured to wirelessly receive audio data and generate audio output. Various examples described herein may reference examples of wireless audio output devices (e.g., ear buds, wireless headphones, wireless speakers, etc.), which are a specific type of wireless audio output device. Throughout this description, any reference to wireless audio output devices is merely provided for illustrative purposes. The example embodiments may be utilized with any electronic component equipped with hardware, software and/or firmware configured to communicate with a source device via a wireless communication protocol and generate audio output.

The example embodiments are also described with regard to a short-range communication protocol that enables short-range communication between two or more devices. Various examples described herein may reference Bluetooth (e.g., Bluetooth, Bluetooth Low-Energy (BLE), etc.), which is a specific type of short-range communication protocol. However, the example embodiments may be implemented using any type of wireless communication protocol or personal area network (PAN), e.g., WiFi Direct, ultrawideband (UWB) networks, etc. Throughout this description, any reference to the terms such as, “Bluetooth,” “short-range communication protocol,” “short-range connection,” or “short-range communication link” is merely provided for illustrative purposes. The example embodiments may apply to any appropriate type of communication protocol.

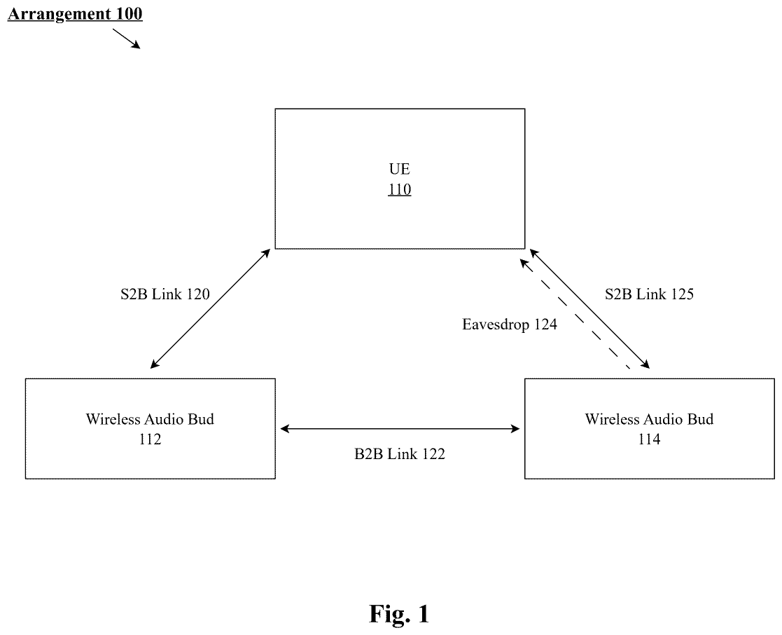

FIG. 1 shows an example arrangement 100 of wireless communication device 110 and wireless audio output devices 112, 114 according to various example embodiments. The example arrangement 100 includes a wireless communication device 110. The wireless communication device 110 may represent any type of electronic component that is capable of communicating with one or more wireless audio output devices. Specific examples of the wireless communication device 110 include, but are not limited to, mobile phones, tablet computers, desktop computers, smartphones, embedded devices, wearables, Internet of Things (IoT) devices, video game consoles, media players, entertainment devices, smart speakers, smart TVs, streaming devices, etc. As mentioned above, the terms “wireless communication device” and “source device” may be used interchangeably throughout this description.

The wireless communication device 110 may communicate with a pair of wireless audio output devices 112, 114 (e.g., ear buds, audio buds, wireless headphones, etc.). However, any reference to wireless audio output device is merely provided for illustrative purposes. The example embodiments may apply to scenarios that include any appropriate type of audio output device, including one or more wireless speakers and devices with one or more integrated speakers.

The example arrangement 100 also illustrates various types of communication links and/or interactions that may occur when using the short-range communication protocol. In some embodiments, a network of these connections may represent a PAN.

The arrangement 100 shows a source-to-audio bud (S2B) link 120 between the wireless communication device 110 and the wireless audio bud 112 (primary bud). In addition, an audio bud-to-audio bud (B2B) link 122 is shown between the wireless audio bud 112 and the wireless audio bud 114 (secondary bud). In this example, the communication links 120, 122 may be Bluetooth connections or any other appropriate type of connection. Therefore, the wireless communication device 110 and the wireless audio output device 112, 114 may be equipped with an appropriate chipset to communicate using a short-range communication protocol.

In some embodiments, the wireless audio bud 114 may be enabled to eavesdrop 124 (or snoop) on data being exchanged on the S2B link 120. In some embodiments, the wireless audio bud 114 may establish a S2B link 125 with the wireless communication device 110. This additional S2B link 125 may be used instead of or in addition to the eavesdrop 124 and the B2B link 122.

Communication links (e.g., S2B 120, S2B 125, B2B 122) may be established using a manual approach, an automated approach or a combination thereof. The manual approach refers to a process in which user input at one or more of the devices triggers the initiation of a connection establishment procedure. The automated approach refers to a mechanism in which connection establishment is initiated without a user-supplied command, e.g., using sensor data, proximity detection, an automated trigger, and/or other operations.

The arrangement 100 illustrates a possible network of short-range connections among the wireless communication device 110 and the wireless audio output device 112, 114. In some example embodiments, the wireless communication device 110 and the audio bud 112 have a primary/secondary relationship over the S2B link 120 where the wireless communication device 110 is in control and/or has priority over the audio bud 112. Similarly, the wireless communication device 110 and the audio bud 114 may also have a primary/secondary relationship over the S2B link 125 where the wireless communication device 110 is in control and/or has priority over the audio bud 114.

In addition, the audio bud 112 and the audio bud 114 may have a primary/secondary relationship over the B2B link 122 where the audio bud 112 is in control and/or has priority over the audio bud 114. In other example embodiments, devices connected via a short-range communication protocol (e.g., S2B link 120, S2B link 125, B2B link 122) may have a mutual relationship where the devices share or negotiate certain responsibilities.

A primary/secondary relationship between audio buds may be dynamic. For example, at a first time, the audio bud 112 may be set as the primary bud and the audio bud 114 may be set as the secondary bud. Subsequently, a predetermined condition may trigger the audio bud 114 to be set as the primary bud. Thus, at a second time, the audio bud 114 may be set as the primary bud and the audio bud 112 may be set as the secondary bud. During a session (e.g., streaming, a call, etc.), the pair of audio buds 112, 114 may switch roles any number of times. However, for purposes of the following description, the wireless audio bud 112 will be referred to as the primary bud and the wireless audio bud 114 will be referred to as the secondary bud.

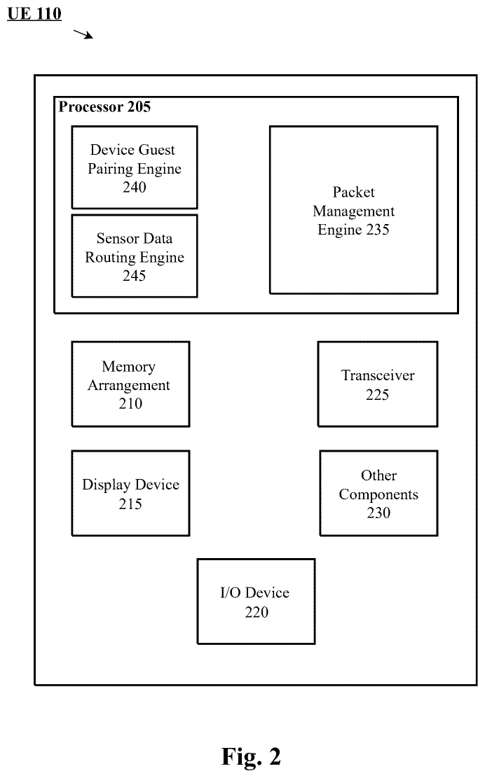

FIG. 2 shows an example wireless communication device 110 according to various example embodiments. The wireless communication device 110 will be described with regard to the arrangement 100 of FIG. 1. The wireless communication device 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the wireless communication device 110 to other electronic devices, etc.

The processor 205 may be configured to execute a plurality of engines of the wireless communication device 110. For example, the engines may include a packet management engine 235. The packet management engine 235 may be configured to perform operations related to processing microphone audio packets from both wireless audio output devices 112,114 and voice accelerometer data.

The engines may also include a Device Guest Pairing Engine 240. The Device Guest Pairing Engine 240 may be configured to perform operations to provide cross-device guest pairing. For example, the Device Guest Pairing Engine 240 may generate and send encryption keys to other devices so that the other devices can connect to each other via a temporary guest link for a specific communications session.

The engines may also include a Sensor Data Routing Engine 245. The Sensor Data Routing Engine 245 may be configured to perform operations to route sensor data between devices. For example, the Sensor Data Routing Engine 245 may receive an indication that sensor data is available from another device and may send a request for that sensor data, where the request may be sent through a secondary device to the device that has the sensor data.

The above referenced engines 235, 240, and 245 being applications (e.g., programs) executed by the processor 205 are merely provided for illustrative purposes. The functionality associated with the engine 235 may also be represented as a separate incorporated component of the wireless communication device 110 or may be a modular component coupled to the wireless communication device 110, e.g., an integrated circuit with or without firmware. For example, the integrated circuit may include input circuitry to receive signals and processing circuitry to process the signals and other information. The engines may also be embodied as one application or separate applications. In addition, in some wireless communication devices, the functionality described for the processor 205 is split among two or more processors such as a baseband processor and an applications processor. The example embodiments may be implemented in any of these or other configurations of a wireless communication device.

The memory arrangement 210 may be a hardware component configured to store data related to operations performed by the wireless communication device 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may represent one or more hardware components configured to perform operations related to wireless communication. For example, the transceiver 225 may represent one or more radios configured to communicate with a cellular network, a PAN, a wireless local area network (WLAN), etc. As indicates above, the example embodiments may include the wireless communication device 110 communicating with a first audio output device over a first frequency band and a second audio output device over a second different frequency band. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein.

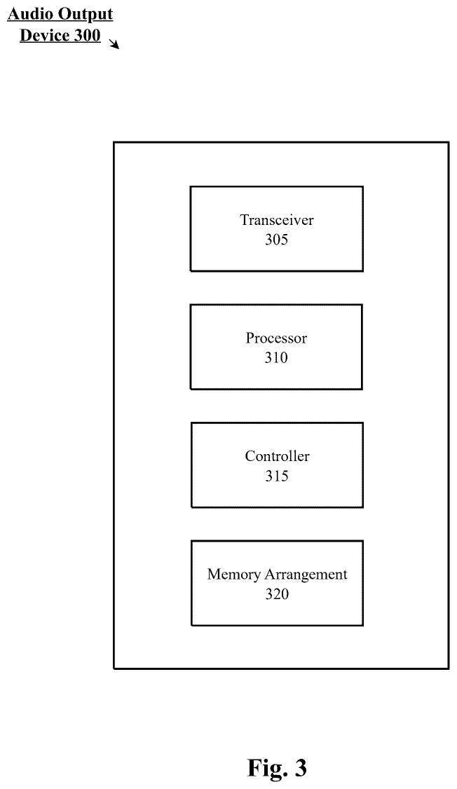

FIG. 3 shows an example audio output device 300 according to various example embodiments. The audio output device 300 may represent either or both of the audio buds 112, 114 shown in the arrangement 100.

The device 300 may include a transceiver 305, a processor 310 and a controller 315. In addition, the device 300 may include other components (not shown) such as, but not limited to, a microphone, a memory, a battery and ports to electrically connect the device 300 to other electronic devices.

The transceiver 305 may represent one or more hardware components configured to perform operations related to wireless communication. For example, the transceiver 305 may represent one or more radios configured to communicate with a PAN or any other appropriate type of network. The transceiver 305 may enable a short-range connection to be established using frequencies or channels associated with the short-range connection (e.g., Bluetooth). The transceiver 305 includes circuitry configured to transmit and/or receive signals (e.g., control signals, data signals). Such signals may be encoded with information implementing any one of the methods described herein. In some embodiments, these frequencies may include the 2.4 GHz and 5 GHz bands. Accordingly, the transceiver 305 may operate on a variety of different frequencies or channels (e.g., set of consecutive frequencies).

The processor 310 may be configured to execute a plurality of engines for the audio output device 300. For example, the processor 310 may perform operations related to receiving connection information from a source device and joining an existing audio session. In some embodiments, the processor 310 may be represented as a separate incorporated component of the audio output device 300 or may be a modular component coupled to the audio output device 300, e.g., an integrated circuit with or without firmware. For example, the processor 310 may be a chip or integrated circuit compatible with the short-range communication protocol that includes input circuitry to receive signals and processing circuitry to process the signals and other information. The engines may also be embodied as one application or separate applications. In some embodiments, the functionality described for the processor 310 is split among two or more processors such as a baseband processor and an applications processor. In other embodiments, the transceiver 305 may also be configured to execute engines and/or operations for the audio output device 300.

The controller 315 may be configured to control the communication functions of the transceiver 305 and/or the processor 310. In addition, the controller 315 may also control non-communication functions related to the other components such as the memory, the battery, etc. Accordingly, the controller 315 may perform operations associated with an applications processor. The example embodiments may be implemented in any of these or other configurations of an audio output device.

The audio output device 300 may also have a memory arrangement 320. The memory arrangement 320 may be a hardware component configured to store data related to operations performed by the audio output device 300. For example, the memory arrangement 320 may store sensor data associated with the audio output device 300.

In some situations, a user may be in an environment that is not a typical location such as home or office. For example, a user may be in a hotel or other location and want to use a secondary source device other than the wireless communication device for audio and video. In one embodiment, the secondary source device may be a smart television, such as an Apple TV. In this situation, it may be desirable to connect and guest pair the wireless communication device and/or the wireless audio output device or other audio output devices to the secondary source device.

In one use case, a user may be in a hotel room and may have a wireless communication device such as a cell phone and a pair of wireless audio output devices. The hotel room may have a secondary source device such as a smart television. The user may desire to participate in a communication session involving both audio and video. The user may wish to display video on the secondary source device (smart television) but have the audio be heard through the wireless audio output devices. For example, the user may wish to participate in a fitness workout, where there is an application on the user's wireless communication device that will present a fitness workout to the user that includes both video and audio content. The fitness workout application may involve video content that illustrates workout information to the user. In addition, the fitness workout application may also display health information to the user such as heart rate, pulse, number of calories burned, and the like, as well as a clock or time information showing the length of the workout. The user's wireless air buds may be already linked to the user's wireless communication device (e.g., cellular phone) or may be automatically linked when in proximity to each other. However, in order to include the secondary source device into the communication session, perhaps in order to display the video content from the fitness workout application, and receive audio through the wireless ear buds, the user must connect the wireless air buds to the secondary source device.

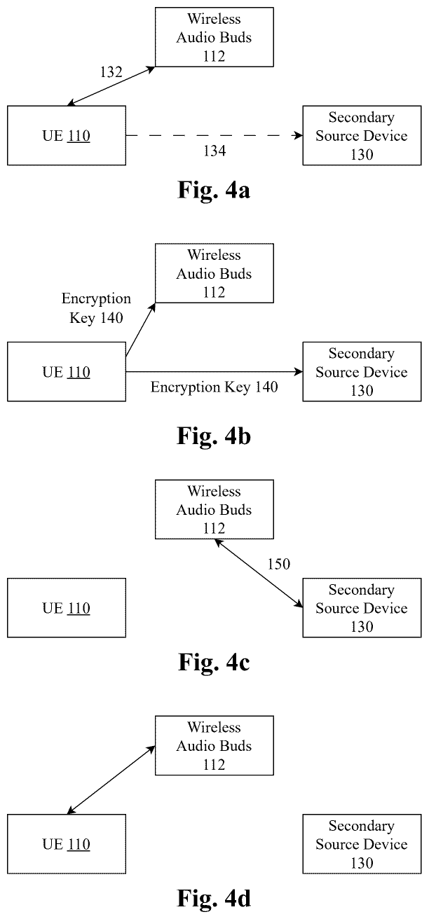

FIGS. 4A-4D illustrate example connections between a wireless communication device, a set of wireless audio output devices, and a secondary source device in an example communications session according to various embodiments. A user's wireless audio output device 112 may be already linked via a link 132 to the user's wireless communication device 110 (e.g., cellular phone) or may be automatically linked when in proximity to each other (see FIG. 4A). This link 132 may be through any known technique, such as BT, BLE or other short-range communication protocol as discussed herein. In the examples of FIGS. 4A-4D, the wireless audio output device will be described as the wireless air bud 112 but the wireless audio output device may be both wireless air buds 112, 114, wireless air bud 114 or a different wireless audio output device, The wireless communication device 110 may contain an application (such as a fitness workout application) which includes both audio and video content being output from the wireless communication device. In one embodiment, the user may connect the wireless communication device 110 to a secondary source device 130, such as a smart television, via a connection 134, which may be made through any known protocol. In some embodiments, the user may start an application (such as the fitness workout application) on the secondary source device 130 and the secondary source device 130 may search for a smart device such as the wireless communication device 110 or other wireless communication device to which it will automatically link or will ask the user if it wants to link the wireless communication device 110 to the secondary source device 130.

Alternatively, the user may then initiate an application on the wireless communication device (such as the fitness workout application) after it is connected to the secondary source device 130. Once the wireless communication device 110 and the secondary source device 130 are connected, and the communication session is initiated, video and audio output may be sent to the secondary source device 130 via the connection 134 such that the audio and video may be displayed through the secondary source device 130.

In the fitness workout example, the video displayed on the secondary source device may include the workout prompts (e.g., the user is told what workout steps to perform) in addition to health information to the user such as heart rate, pulse, number of calories burned, and the like, as well as a clock or time information showing the length of the workout.

If the user would like to have the video displayed on the secondary source device 130 but would like to have the audio handled through the wireless audio output device 112, the user may in one example embodiment manually select the wireless audio output device 112 to receive the audio. In one example embodiment, a user may send a request to the wireless communication device 110 or to the secondary source device 130 that audio for the communication session be transmitted by the apparatus to the wireless audio output device. In any event, the wireless communication device 110 may determine that audio for the first communication session is desired to be though a wireless audio output device associated with the apparatus.

In other example embodiments, once the secondary source device 130 is selected to be used with the wireless communication device 110 and the wireless audio output device 112 is either already linked to the wireless communication device 110 or the wireless audio output device 112 is detected as being on and in proximity to the wireless communication device 110 and/or the secondary device 130, the wireless audio output device 112 may automatically be selected to receive the audio, via the wireless audio output device′ connection with the wireless communication device 110. In one embodiment, the secondary source device 130 may detect that the wireless air bud 112 are in proximity to the secondary source device 130 and may send a request to the wireless communication device 110 to be connected to the wireless audio output device 112.

However, since the secondary source device 130 is not owned or controlled by the user in this scenario, it may not be possible to automatically link the wireless audio output device 112 to the secondary source device 130. Further, it may be desirable not to exchange the user's private or personal information relating to the wireless communication device 110 and the wireless audio output device 112. Thus, in some example embodiments, there is a need to connect and guest pair the wireless communication device and/or the wireless audio output device 112 or other audio output devices to the secondary source device 130.

In some example embodiments, as shown in FIG. 4B, once the wireless communication device determines that audio for the communication session is desired to be though the wireless audio output device 112, the wireless communication device 110 may send encryption keys 140 to the wireless audio output device 112 and to the secondary source device 130. The sending of the encryption keys 140 may be in response to a user input through the wireless communication 110, the secondary source device 130, or other device, where the user inputs an indication that the user wants the audio to be sent to the wireless audio output device 112. In another embodiment, the encryption keys 140 may be automatically sent to the secondary source device 130 and the wireless audio output device 112 upon the wireless communication device 110 sensing a connection (wireless or wired) with the secondary source device 130 or sensing that the secondary source device 130 is in proximity to the wireless communication device 130. In another embodiment, the wireless communication device 110, upon sensing a connection (wireless or wired) with the secondary source device 130 or sensing that the secondary source device 130 is in proximity to the wireless communication device 110, may provide the user with an indication of the relationship with the secondary source device 130 and may ask the user if the user wishes to have audio sent to the wireless audio output device 112. Upon an affirmative response, the wireless communication device 110 may send encryption keys 140 to the wireless audio output device 112 and to the secondary source device 130.

In some example embodiments, the transmission of the encryption keys 140 may be done via BT or BLE pairing, where no code or password of the user is needed. In some example embodiments, the encryption keys 140 are temporary and only used for a single communication session between the wireless communication device 110, the wireless audio output device 112, and the secondary source device 130. Using the encryption keys 140, the secondary source device 130 connects to the wireless audio output device 112 via a guest pairing link 150 (see FIG. 4C). The guest pairing link 150 may be via BT or other short-range wireless protocol. The communications session may then be carried out over guest pairing link 150, with the video being displayed on the secondary source device and the audio being presented (from the secondary source device 130) to the wireless audio output device 112. Once the communication session (e.g., the fitness workout) is complete, the wireless audio output device 112 is disconnected from the secondary source device 130, with the guest pairing link 150 being taken down (see FIG. 4D). The disconnection may be session-based, or it may be triggered by a timer timing out.

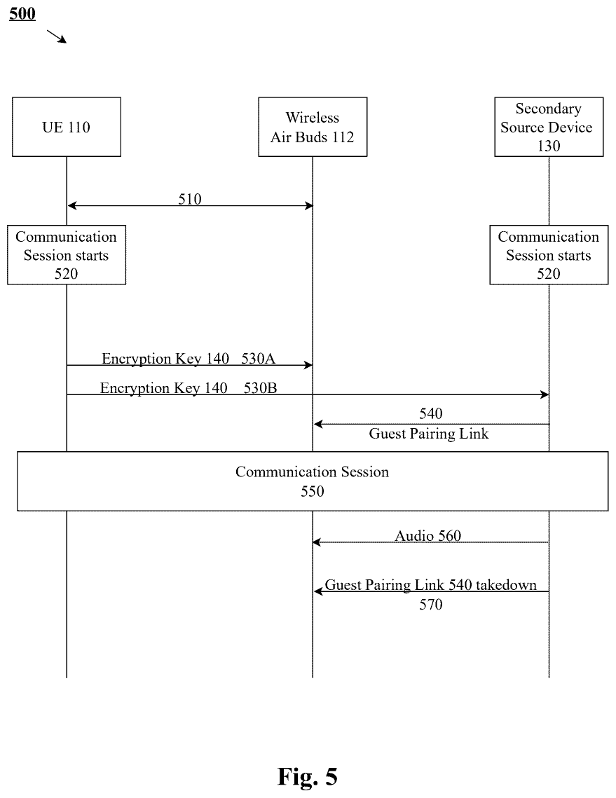

FIG. 5 shows an example flow diagram for a method of communicating wirelessly between a wireless communication device, a set of wireless audio output devices, and a secondary source device in an example communications session that uses a guest pairing between the wireless audio output device and the secondary source device according to various embodiments. In the flow diagram 500 of FIG. 5, a user's wireless audio output device 112 may be already linked via a link to the user's wireless communication device 110 (e.g., cellular phone) or may be automatically linked when in proximity to each other (510). This link may be through any known technique, such as BLE or other short-range communication protocol as discussed herein. In one embodiment, the wireless communication device 110 may already be connected to the secondary source device 130 (not shown), or the user may connect the wireless communication device 110 to a secondary source device 130, such as a smart television, via a connection, which may be made through any known protocol. In some embodiments, the user may start an application (such as the fitness workout application) on the wireless communication device 110 and/or the secondary source device 130, and a communication session may start (520). At this point, video and audio output may be sent to the secondary source device 130 such that the audio and video may be displayed through the secondary source device 130.

If the user would like to the audio handled through the wireless audio output device 112, the user may in one embodiment manually select the wireless audio output device 112 to receive the audio. In other example embodiments, once the secondary source device 130 is selected to be used with the wireless communication device 110 and the wireless audio output device 112 are either already linked to the wireless communication device 110 or the wireless audio output device 112 is detected as being on and in proximity to the wireless communication device 110 and/or the secondary device 130, the wireless audio output device 112 may automatically be selected to receive the audio, via the wireless audio output device 112 connection with the wireless communication device 110. However, since the secondary source device 130 is not owned or controlled by the user in this scenario, it may not be possible to automatically link the wireless audio output device 112 to the secondary source device 130. Further, it may be desirable not to exchange the user's private or personal information relating to the wireless communication device 110 and the wireless audio output device 112.

Thus, in some example embodiments, the wireless communication device 110 may send encryption keys 140 to the wireless audio output device 112 (530A) and to the secondary source device 130 (530B). The encryption keys 140 may take any known form and may be sent via any known protocols. In some example embodiments, the transmission of the encryption keys 140 may be done via BT or BLE pairing, where no code or password of the user is needed. In some embodiments, the encryption keys 140 are temporary and only used for a single communication session between the wireless communication device 110, the wireless audio output device 112, and the secondary source device 130. Using the encryption keys 140, the secondary source device 130 connects to the wireless air buds 112 via a guest pairing link (540). The guest pairing link may be via BT, BLE, or other short-range wireless protocol. The communications session may then be carried out over the guest pairing link (550). The video may be displayed on the secondary source device and the audio being presented (from the secondary source device 130) to the wireless air buds 112 (560). Once the communication session (e.g., the fitness workout) is complete, the wireless audio output device 112 are disconnected from the secondary source device 130, with the guest pairing link being taken down (570). The disconnection may be session-based, or it may be triggered by a timer timing out.

In another aspect, it may be useful to be able to route sensor data from an accessory device (e.g. wireless air buds) to a particular secondary source device or to a wireless communication device, regardless of connection status. Wireless audio output device 112 as disclosed herein may be considered an accessory device in some embodiments. In some situations, the wireless audio output device 112 or other accessory device may have sensor data and it may be useful to send the sensor data to other wireless communication devices. For example, the wireless audio output device 112 may be connected to a secondary source device 130, such as a smart television. This connection may be accomplished via the techniques described above with respect to FIGS. 4A-4D and 5. In one embodiment, the wireless audio output device may be Apple AirPods and the secondary source device may be an Apple TV.

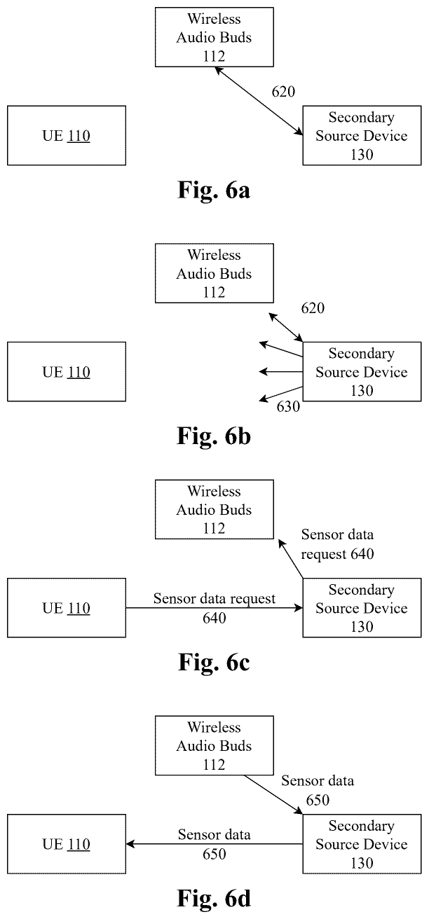

FIGS. 6A-6D illustrate example connections between a wireless communication device, a set of wireless audio output devices, and a secondary source device in an example communications session where sensor data is sent from the wireless air buds to the wireless communication device through the secondary source device acting as a relay according to various embodiments.

In some example embodiments, the wireless audio output device 112 may be connected to a secondary source device 130, such as a smart television, via a link 620 (see FIG. 6A). This connection may be accomplished via the techniques described above with respect to FIGS. 4A-4D and 5, or via any other appropriate technique. The link 620 may be established through any known technique, such as BT, BLE or other short-range communication protocol as discussed herein.

In some example embodiments, the secondary source device 130 may advertise that sensor data is available via the wireless audio output device 112. In some embodiments, upon a connection (wireless or wired) being made between the wireless audio output device 112 and the secondary source device 130, the wireless audio output device 112 may, according to standard behavior, send an indication to the secondary source device 130 that it has the capability to send sensor data. The secondary source device 130 may then advertise that sensor data is available from the wireless audio output device 112. The advertisement may be through broadcasts 630 sent from the secondary source device 130 (see FIG. 6B). The sensor data may include heart rate monitor information, pulse, body temperature, calorie burning information, and the other health related information. As above, in one example, the user may wish to participate in a fitness workout, where there is an application on the user's wireless communication device that will present a fitness workout to the user that includes both video and audio content. The fitness workout application may involve video content that illustrates workout information to the user. In addition, the fitness workout application may also display health information to the user such as heart rate, pulse, number of calories burned, and the like, as well as a clock or time information showing the length of the workout. The user's wireless air buds may be already linked to the user's wireless communication device (e.g., cellular phone) or may be automatically linked when in proximity to each other.

In some example embodiments, the user may connect the wireless communication device 110 to a secondary source device 130, such as a smart television, via a connection 134, which may be made through any known protocol. In some embodiments, the user may start an application (such as the fitness workout application) on the secondary source device 130 and the secondary source device 130 may search for a smart device such as the wireless communication device 110 or other wireless communication device to which it will automatically link or will ask the user if it wants to link the wireless communication device 110 to the secondary source device 130. Alternatively, the user may then initiate an application on the wireless communication device (such as the fitness workout application) after it is connected to the secondary source device 130. Once the wireless communication device 110 and the secondary source device 130 are connected, and the communication session is initiated, video and audio output may be sent to the secondary source device 130 via the connection 134 such that the audio and video may be displayed through the secondary source device 130.

Once the user initiates the application on the wireless communication device 110, the fitness workout or other communication session starts on the wireless communication device 110. The wireless communication device 110 may then send a request 640 for sensor data from the wireless audio output device 112 through the secondary source device 130 (see FIG. 6C). The secondary source device 130 may forward this request to the wireless audio output device 112. In some example embodiments, the request may be triggered when the wireless communication device 110 detects that the secondary source device 130 is connected to the wireless audio output device 112 that has sensor data capabilities. In other embodiments, the secondary source device 130 may request any available sensor data from the wireless audio output device 112 upon initial connection to the wireless audio output device 112.

In response to the request for sensor data, the wireless audio output device 112 sends a response 650 with the sensor data to the wireless communication device 110 through the secondary source device 130 (see FIG. 6D). The secondary source device 130 takes sensor data that it receives from the wireless audio output device 112 in response 650 and forwards the sensor data to the wireless communication device 110.

In this manner, the secondary source device 130 acts as a relay for the sensor information from the wireless audio output device 112 to the wireless communication device 110. Note that no password is needed because all the devices here have an existing relationship since the wireless air buds are connected to the secondary source device 130. Also note that in general, and in many situations, it is not desirable for wireless audio output devices to be simultaneously connected to multiple wireless communication devices. Thus, where the wireless audio output device 112 are connected to the secondary source device 130, the secondary source device 130 acts as a relay to send information from the wireless audio output device 112 to the wireless communication device 110 rather than the wireless audio output device 112 also being connected to the wireless communication device 110 and sending the information directly to the wireless communication device 110.

Once the wireless communication device 110 receives the sensor data from the wireless audio output device 112, the wireless communication device 110 may use that sensor data in the communications session. For example, in the fitness workout example, the wireless communication device 110 may receive heart rate monitor information, pulse, body temperature, calorie burning information, and the other health related information, and this information may be used to adjust or modify the workout session.

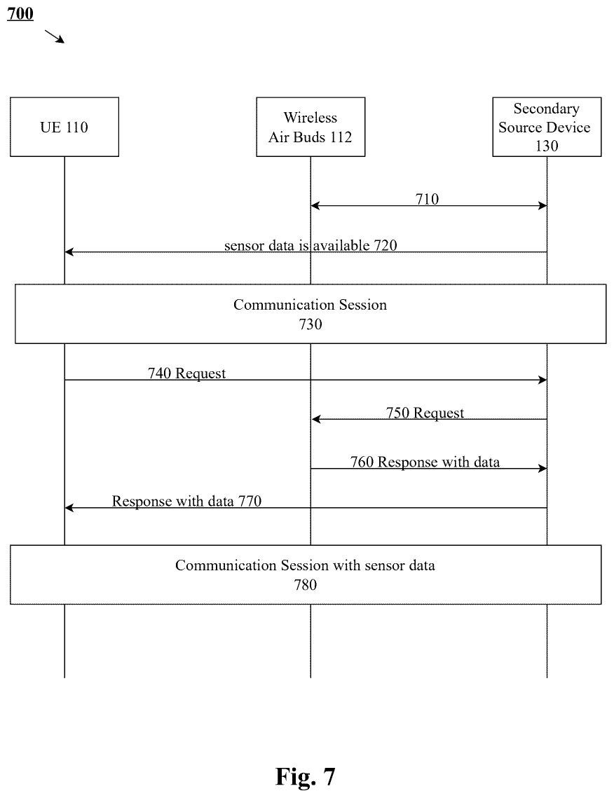

FIG. 7 shows an example flow diagram for a method of communicating wirelessly between a wireless communication device, a wireless audio output device, and a secondary source device in an example communications session where sensor data is sent from the wireless air buds to the wireless communication device through the secondary source device acting as a relay according to various embodiments. In the flow diagram 700 of FIG. 5, a user's wireless audio output device 112 may be already linked via a link to a secondary source device 130 (710). This connection may be accomplished via the techniques described above with respect to FIGS. 4A-4D and 5, or via any other appropriate technique. The link may be established through any known technique, such as BT, BLE or other short-range communication protocol as discussed herein.

In some example embodiments, the wireless communication device 110 may already be connected to the wireless audio output device 112 (not shown) or may be automatically linked when in proximity to each other. In one embodiment, the secondary source device 130 may advertise that sensor data is available via the wireless audio output device 112 (720). In some embodiments, upon a connection (wireless or wired) being made between the wireless audio output device 112 and the secondary source device 130, the wireless audio output device 112 may, according to standard behavior, send an indication to the secondary source device 130 that it has the capability to send sensor data. The secondary source device 130 may then advertise that sensor data is available from the wireless audio output device 112. The advertisement may be through broadcasts sent from the secondary source device 130.

Assuming the wireless communication device 110 and the secondary source device 130 are connected, once the user initiates the application on the wireless communication device 110, the fitness workout or other communication session starts and the wireless communication device 110, the wireless audio output device 112, and the secondary source device 120 may be involved in the communications session (730). The wireless communication device 110 may then send a request for sensor data from the wireless audio output device 112 through the secondary source device 130 (740). In some example embodiments, the request may be triggered when the wireless communication device 110 detects that the secondary source device 130 is connected to the wireless audio output device 112 that has sensor data capabilities. In some embodiments, the secondary source device 130 may request any available sensor data from the wireless audio output device 112 upon initial connection to the wireless audio output device 112.

The secondary source device 130 may thus send a request directly or may forward a request from the wireless communication device 110 to the wireless audio output device 112 (750). In response to the request, the wireless air buds 112 sends a response with the sensor data to the secondary source device 130 (760). The secondary source device 130 takes sensor data that it receives from the wireless air buds in the response and forwards the sensor data to the wireless communication device 110 (770). In this manner, the secondary source device 110 acts as a relay for the sensor information from the wireless audio output device 112 to the wireless communication device 110.

Once the wireless communication device 110 receives the sensor data from the wireless audio output device 112, the wireless communication device 110 may use that sensor data in the communications session (780). For example, in the fitness workout example, the wireless communication device 110 may receive heart rate monitor information, pulse, body temperature, calorie burning information, and the other health related information, and this information may be used to adjust or modify the workout session.

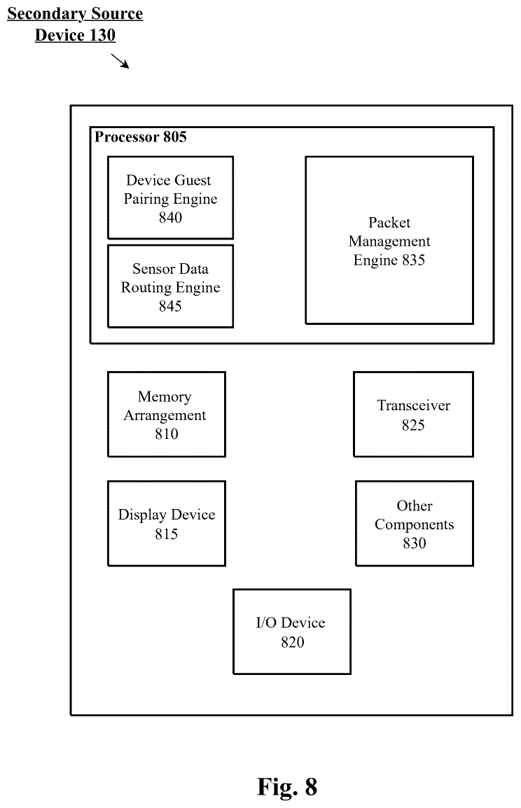

FIG. 8 shows an example secondary source device 130 according to various example embodiments. The secondary source device 130 may include a processor 805, a memory arrangement 810, a display device 815, an input/output (I/O) device 820, a transceiver 825 and other components 830. The other components 830 may include, for example, an audio input device, an audio output device, a power supply, a data acquisition device, ports to electrically connect the secondary source device 130 to other electronic devices, etc.

The processor 805 may be configured to execute a plurality of engines of the secondary source device 130. For example, the engines may include a packet management engine 835. The packet management engine 835 may be configured to perform operations related to processing microphone audio packets from both wireless audio output devices 112,114 and wireless communication device 110 as well as voice accelerometer data.

The engines may also include a Device Guest Pairing Engine 840. The Device Guest Pairing Engine 840 may be configured to perform operations to provide cross-device guest pairing. For example, the Device Guest Pairing Engine 840 may receive encryption keys from other devices so that the secondary source device 130 can connect to other devices via a temporary guest link for a specific communications session.

The engines may also include a Sensor Data Routing Engine 845. The Sensor Data Routing Engine 845 may be configured to perform operations to route sensor data between devices. For example, the Sensor Data Routing Engine 845 may send or receive an indication that sensor data is available from another device and may send a request for that sensor data, and may then forward that sensor data to another device.

The above referenced engines 835, 840, and 845 being applications (e.g., programs) executed by the processor 805 are merely provided for illustrative purposes. The functionality associated with the engines 835, 840, and 845 may also be represented as a separate incorporated component of the secondary source device 130 or may be a modular component coupled to the secondary source device 130, e.g., an integrated circuit with or without firmware. For example, the integrated circuit may include input circuitry to receive signals and processing circuitry to process the signals and other information. The engines may also be embodied as one application or separate applications. In addition, in some wireless communication devices, the functionality described for the processor 805 is split among two or more processors such as a baseband processor and an applications processor. The example embodiments may be implemented in any of these or other configurations of a wireless communication device.

The memory arrangement 810 may be a hardware component configured to store data related to operations performed by the secondary source device 130. The display device 815 may be a hardware component configured to show data to a user while the I/O device 820 may be a hardware component that enables the user to enter inputs. The display device 815 and the I/O device 820 may be separate components or integrated together such as a touchscreen.

The transceiver 825 may represent one or more hardware components configured to perform operations related to wireless communication. For example, the transceiver 825 may represent one or more radios configured to communicate with a cellular network, a PAN, a wireless local area network (WLAN), etc. As indicates above, the example embodiments may include the secondary source device 130 communicating with a first audio output device over a first frequency band and a second audio output device over a second different frequency band.

Accordingly, the transceiver 825 may operate on a variety of different frequencies or channels (e.g., set of consecutive frequencies). The transceiver 825 includes circuitry configured to transmit and/or receive signals (e.g., control signals, data signals). Such signals may be encoded with information implementing any one of the methods described herein.

### EXAMPLES

In a first example, a method, comprising connecting to a wireless communication device associated with a wireless audio output device for a first communication session between the apparatus and the wireless communication device, receiving an encryption key from the wireless communication device, establishing a guest pairing link with the wireless audio output device using the encryption key and transmitting audio data for the communication session to the wireless audio output device.

In a second example, the method of the first example, further comprising receiving audio data and video data from the wireless communication device during the first communication session.

In a third example, the method of the second example, further comprising displaying the video data.

In a fourth example, the method of the third example, wherein the video data comprises health-related information including one or more of heart rate, pulse, body temperature, number of calories burned, and length of workout.

In a fifth example, the method of the first example, further comprising detecting that the wireless audio output device is in proximity to the apparatus and generating, for transmission to the wireless communication device, a request for information to be able to link to the wireless audio output device.

In a sixth example, the method of the first example, further comprising processing the encryption key in response to a user request that audio for the communication session is to be transmitted to the wireless audio output device.

In a seventh example, the method of the first example, wherein the guest painting link is established via a short-range wireless communication protocol.

In an eighth example, the method of the first example, wherein the encryption key is temporary and only for the first communication session.

In a ninth example, the method of the first example, further comprising disconnecting from the wireless audio output device by taking down the guest pairing link.

In a tenth example, the method of the first example, further comprising disconnecting from the wireless audio output device by taking down the guest pairing link in response to receiving an indication that the first communication session has ended or in response to an expiration of a timer.

In an eleventh example, the method of the first example, further comprising advertising that sensor data is available from the wireless audio output device.

In a twelfth example, the method of the eleventh example, further comprising receiving a request from the wireless communication device for the sensor data.

In a thirteenth example, the method of the twelfth example, further comprising forwarding the request for sensor data to the wireless audio output device.

In a fourteenth example, the method of the thirteenth example, further comprising receiving sensor data from the wireless audio output device in response to the forwarded request and forwarding the sensor data to the wireless communication device.

In a fifteenth example, the method of the fourteenth example, further comprising displaying the sensor data.

In a sixteenth example, the method of the eleventh example, wherein the sensor data comprises health-related information including one or more of heart rate, pulse, body temperature, number of calories burned, and length of workout.

In a seventeenth example, a processor configured to perform any of the methods of the first through sixteenth examples.

In an eighteenth example, a wireless communication device configured to perform any of the methods of the first through sixteenth examples.

In a nineteenth example, a method, comprising connecting to a wireless communication device associated with a wireless audio output device for a first communication session between the apparatus and the wireless communication device, establishing a link with the wireless audio output device, advertising that sensor data is available from the wireless audio output device, receiving a request from the wireless communication device for the sensor data, forwarding the request for sensor data to the wireless audio output device, receiving sensor data from the wireless audio output device in response to the forwarded request and forwarding the sensor data to the wireless communication device.

In a twentieth example, the method of the nineteenth example, further comprising displaying the sensor data.

In a twenty first example, the method of the nineteenth example, wherein the sensor data comprises health-related information including one or more of heart rate, pulse, body temperature, number of calories burned, and length of workout.

In a twenty second example, a processor configured to perform any of the methods of the nineteenth through twenty first examples.

In a twenty third example, a wireless communication device configured to perform any of the methods of the nineteenth through twenty first examples.

In a twenty fourth example, a method, comprising connecting to a secondary source device for a first communication session between the apparatus and the secondary source device, determining that audio for the first communication session is desired to be though a wireless audio output device associated with the apparatus, and generating, for transmission to the secondary source device, an encryption key configured to allow the secondary source device to establish a guest pairing link with the wireless audio output device.

In a twenty fifth example, the method of the twenty fourth example, further comprising receiving a broadcast from the secondary source device that sensor data is available from the wireless audio output device, generating, for transmission to the secondary source device, a request for the sensor data, and receiving the sensor data from the wireless audio output device through the secondary source device.

In a twenty sixth example, a processor configured to perform any of the methods of the twenty fourth through twenty fifth examples.

In a twenty seventh example, a wireless communication device configured to perform any of the methods of the twenty fourth through twenty fifth examples.

In a twenty eighth example, a method, comprising connecting and pair to a wireless communication device for a first communication session between the apparatus and the wireless communication device, receiving an encryption key from the wireless communication device, the encryption key being temporary for the first communication session, connecting to a secondary source device linked to the wireless communication device through a guest pairing link using the encryption key and receiving audio data for the first communication session from the secondary source device.

In a twenty ninth example, the method of the twenty eighth example, further comprising receiving a request from the secondary source device for sensor data associated with the apparatus, the request originating from the wireless communication device and transmitting the sensor data to the secondary source device, the sensor data to be forwarded to the wireless communication device.

In a thirtieth example, a processor configured to perform any of the methods of the twenty eighth through twenty ninth examples.

In a thirty first example, a wireless communication device configured to perform any of the methods of the twenty eighth through twenty ninth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above-described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry coupled to memory, wherein the processing circuitry is configured to:
connect to a wireless communication device associated with a wireless audio output device for a first communication session between the apparatus and the wireless communication device;
receive an encryption key from the wireless communication device;
establish a guest pairing link with the wireless audio output device using the encryption key; and
generate, for transmission to the wireless audio output device, audio data for the communication session.

2. The apparatus of claim 1, wherein the processing circuitry is further configured to receive audio data and video data from the wireless communication device during the first communication session.

3. The apparatus of claim 2, wherein the processing circuitry is configured to display the video data.

4. The apparatus of claim 3, wherein the video data comprises health-related information including one or more of heart rate, pulse, body temperature, number of calories burned, and length of workout.

5. The apparatus of claim 1, wherein the processing circuity is configured to:
detect that the wireless audio output device is in proximity to the apparatus; and
generate, for transmission to the wireless communication device, a request for information to be able to link to the wireless audio output device.

6. The apparatus of claim 1, wherein the processing circuity is configured to process the encryption key in response to a user request that audio for the communication session be transmitted by the apparatus to the wireless audio output device.

7. The apparatus of claim 1, wherein the guest painting link is established via a short-range wireless communication protocol.

8. The apparatus of claim 1, wherein the encryption key is temporary and only for the first communication session.

9. The apparatus of claim 1, wherein the processing circuitry is configured to disconnect from the wireless audio output device by taking down the guest pairing link.

10. The apparatus of claim 1, wherein the processing circuitry is configured to disconnect from the wireless audio output device by taking down the guest pairing link in response to receiving an indication that the first communication session has ended or in response to an expiration of a timer.

11. The apparatus of claim 1, wherein the processing circuitry is configured to advertise that sensor data is available from the wireless audio output device.

12. The apparatus of claim 11, wherein the processing circuitry is configured to receive a request from the wireless communication device for the sensor data.

13. The apparatus of claim 12, wherein the processing circuitry is configured to cause transceiver circuitry to forward the request for sensor data to the wireless audio output device.

14. The apparatus of claim 13, wherein the processing circuitry is configured to:
receive sensor data from the wireless audio output device in response to the forwarded request; and
cause transceiver circuitry to forward the sensor data to the wireless communication device.

15. The apparatus of claim 11, wherein the sensor data comprises health-related information including one or more of heart rate, pulse, body temperature, number of calories burned, and length of workout.

16. An apparatus comprising processing circuitry coupled to memory, wherein the processing circuitry is configured to:
connect to a wireless communication device associated with a wireless audio output device for a first communication session between the apparatus and the wireless communication device;
establish a link with the wireless audio output device;
advertise that sensor data is available from the wireless audio output device;
receive a request from the wireless communication device for the sensor data;
forward the request for sensor data to the wireless audio output device;
receive sensor data from the wireless audio output device in response to the forwarded request; and
cause transceiver circuitry to forward the sensor data to the wireless communication device.

17. The apparatus of claim 16, wherein the processing circuitry is configured to display the sensor data.

18. The apparatus of claim 16, wherein the sensor data comprises health-related information including one or more of heart rate, pulse, body temperature, number of calories burned, and length of workout.

19. An apparatus comprising processing circuitry coupled to memory, wherein the processing circuitry is configured to:
connect to a secondary source device for a first communication session between the apparatus and the secondary source device;
determine that audio for the first communication session is desired to be though a wireless audio output device associated with the apparatus;
generate, for transmission to the secondary source device, an encryption key configured to allow the secondary source device to establish a guest pairing link with the wireless audio output device.

20. The apparatus of claim 19, wherein the processing circuitry is configured to:
receive a broadcast from the secondary source device that sensor data is available from the wireless audio output device;
generate, for transmission to the secondary source device, a request for the sensor data;
receive the sensor data from the wireless audio output device through the secondary source device.
